(19) United States
(12) Patent Application Publication
(10) Pub. No.: US 2003/0205306 A1
(43) Pub. Date: Nov. 6, 2003

(54) Air no air elastomeric tire

(76) Inventor: Richard A. Steinke, Boulder City, NV (US)

Correspondence Address: M. Reid Russell, 1240 East 100 South #10, St. George, UT, 84790, US

(21) Appl. No.: 10/412,471

(22) Filed: Apr. 9, 2003

Related U.S. Application Data
(63) Continuation-in-part of application No. 09/665,604, filed on Sep. 20, 2000, now abandoned.
(63) Continuation-in-part of application No. 09/943,814, filed on Sep. 4, 2001, now abandoned.

(51) Int. Cl. B60C 3/00; B60C 5/01

(52) U.S. Cl. 152/327; 152/452; 152/454; 152/523

(57) ABSTRACT

An elastomeric tire for mounting onto a rim that is manufactured by casting or molding methods to include an interior arch shaped cavity that is centered under the tire tread to have at least one hundred forty (140) degrees and not more than one hundred seventy (170) degrees of arc, and with the cavity arch duplicated around the tire exterior, below the tire tread. A uniform tire wall thickness is provided that is selected for a particular anticipated load as the tire will carry, with the tire side wall ends maintained at the rim aligned ends, supporting the load carried by the tire in compression, and with the tire, at atmospheric pressure, providing ride and wear characteristics that are comparable to a pressurized pneumatic tire carrying a like load, and which tire of the invention interior arch shaped cavity can be pressurized to add to its inherent load supporting character to safely support even greater loads.

### BACKGROUND OF INVENTION

This application is a second continuation-in-part application of an application Ser. No. 09/665,604 for an “AIR NO AIR ELASTOMERIC TIRE” filed Sep. 20, 2000, and a continuation-in-part application Ser. No. 09/943,814 for an “AIR NO AIR ELASTOMERIC TIRE” filed Sep. 4, 2001 that is abandoned with the entry of this second CIP application.

1. Field of the Invention

This invention pertains to non-pneumatic tires for mounting onto a rim as a component of a wheel, and particularly to a tire that is formed, preferably by molding methods, from an elastomeric material, having a center cavity whose walls are capable bearing a load, allowing the tire to safely support a design load with only air at ambient pressure therein, and the center cavity can be aired to a desired pressure to support a greater load.

2. Prior Art

The present invention contemplates a new and improved tire that, while simple in design, is revolutionary in its concept, constituting a major improvement in the tire industry. The tire of the invention will exhibit the ride and wear characteristics of, or are better than that of, a conventional pneumatic tire, that is intended for a like use to the tire of the invention. Which tire of the invention has, by its construction and wall thickness selection, an inherent load bearing capability that is essentially equivalent to the load bearing capability of a like size of pneumatic tire. So arranged, without air, the tire of the invention will still provide load bearing support to a vehicle on which it is mounted. Further, the tire can additionally be aired to a desired greater pressure for supporting a higher or greater load.

Elastomeric, solid, cavity free, non-pneumatic tires have been used for many years going back to as early as 1878, as set out in a British Patent No. 2,367, that shows a solid rubber tire and rim. Even where such rubber tires have been formed to include inner cavities, as illustrated in U.S. Pat. Nos. 450,816 and 464,767 such have not considered the function of a uniform tire relationship between the wall thickness between the tire inner wall and outer wall under the tread, as does the invention, for carrying different loads, and with arcs of some of the wheels of the 464,767 patent outer surfaces shown as formed to have a greater than one hundred seventy degrees of arch, as called for in the invention. While solid rubber tires having cavities are also shown in U.S. Pat. Nos. 612,583; 684,157; and 1,670,446, the cavities of these patents are circles or modified circles and they do not include any recitation of a relationship in any of the embodiments where the cavity is supported by rim edges at ends of one hundred seventy degrees or arc or less, for providing columnar support to a load applied to the tire tread area, as called for by the invention. Further, while a U.S. Pat. No. 1,014,318 shows, in FIG. 1, a tire having an arch shaped cavity and with the tire side wall ends maintained between hook ends of a rim, the patent is directed to rim configurations only and there is no discussion of a relationship between load bear capabilities as relates of wall thickness between the inner and outer arch surfaces. Finally, while cavities are shown in the wheels of U.S. Pat. Nos. 3,948,30; 5,524,913; 5,988,764; 6,145,937; 6,186,598, and 6,318,428, these patents are directed to tire mountings to a rim, or, as in U.S. Pat. No. 2,779,380 to a tubeless tire; in U.S. Pat. No. 3,329,192 to a cross bar tire mounting, or in U.S. Pat. No. 6,279,631, to a low pressure tire, and there is no discussion of loading bear capabilities of the tire and wheel arrangements, as shown, in conjunction with the unique arch shaped interior cavity. Only the present invention recognizes the load bearing capabilities of an elastomeric tire have a centered arch shaped cavity of no greater than one hundred seventy degrees of arc between rim support ends and relates load bearing capability of a tire with such arch shaped inner cavity at atmospheric or ambient pressure to wall thickness between the arch shaped cavity surface and the tire outer surface, below the tread.

A number of later patents that also show non-pneumatic tire and tire and rim combinations include, for example, British Pat. No.'s 3,432; 20,186; and 27,224, French Patents No.'s 338,920 and 367,981 and U.S. Pat. Nos. 1,056,976; 1,178,887; 3,533,662 and 5,229,047. Which patents, however do not show an arch shaped inner cavity. Further, non-pneumatic tires that do not include a center cavity are shown in earlier U.S. Pat. Nos. 4,855,096; 4,943,323, 5,906,836 and 6,165,397 that were co-invented by the present inventor. Additionally, other earlier patents covering non-pneumatic tires that include inner cavities that are not arch shaped, are shown in early British Patent No.'s 11,800 and 14,997; along with early U.S. Pat. Nos. 1,194,177 and 1,670,721. Such cavities are set out as for allowing compressions of the tire side walls and bead sections so as to allow the tire to be fitted into a rim, and for cushioning, and where such cavities have provided load bearing capabilities, like those shown in early U.S. Pat. Nos. 1,004,480 and 1,004,481, such have not been cast tires like that of the invention. None of which solid non-pneumatic tires, have included an arch shaped cavity having a load bearing capability as governed by wall thickness like that of the invention, where the tire side wall is of uniform thickness, under the tread. While, of course, a tire has had a uniform wall thickness, as, for example, as shown in U.S. Pat. Nos. 1,707,014; 1,940,077 and 3,888,291, such side walls are not load bearing when the tire is depressurized to approximately atmospheric pressure.

It is, of course, well known that non-pneumatic tires, such as those shown in some of the above cited prior art patents, have the advantage of not going flat. Heretofore, however, this advantage has not outweighed the better cushioning and shock absorbing characteristics presented by a pneumatic tire as well as the fact that solid tires, whether formed from rubber, urethane, or the like, tend to build up heat through hysteresis flexure when supporting a significant load. Pneumatic tires generally have less mass than a comparable non-pneumatic tire and, with their internal cavity tends to dissipate heat. The tire of the invention is preferably molded to include a central cavity that, dependent upon the rim configuration, can be air retaining and, accordingly, like the pneumatic tire with its open interior, will not experience a damaging heat build-up under a significant load.

Unique to the invention, its interior cavity is formed as a load bearing arch of at least one hundred forty (140) and no more than one hundred seventy (170) degrees or arc to provide an inherent load support strength for the wall thickness between the arch shaped cavity wall and the tire outer wall, under the tread. Thereby, the tire of the invention with the tire arch shaped cavity pressurized to atmospheric pressure only, will exhibit a load bearing capacity in relation to its wall thickness for supporting a wide range of tire loads. The tire of the invention will not experience a flat, and, additionally, the arch shaped tire cavity of the invention can be pressurized to more than atmospheric pressure to increase its inherent load bearing character.

The arch design of the invention transfers loads uniformly from the tread through the arch and into a rim whereto the tire is mounted. The load as the tire will maintain when the cavity is at ambient air pressure is determined by the width or thickness of the tire between the arch shaped cavity wall and the tire outer surface, under the tread. The greater the load, the thicker the wall thickness needs to be to maintain the load. Except, however, to maintain a greater load with normal or lesser wall thickness, the arch shaped cavity can be aired to a greater than atmospheric pressure. The tire of the invention can, within the scope of this disclosure, include beads for maintaining it onto a rim, and can include side wall plies and tread reinforcement with a belt or belts that can be installed in the tire during the manufacturing process.

### SUMMARY OF THE INVENTION

It is a principal object of the present invention to provide an elastomeric tire formed by molding methods to include an internal arch shaped cavity where the cavity arch is centered under the tire tread to provide structural support to safely transfer loads from the tire tread through the side walls and into the rim, supporting the tire under load, and which cavity can receive air under pressure for providing additional load supporting capability.

Another object of the present invention is to provide an elastomeric tire having a center arch shaped cavity where the distance across the center cavity the center cavity wall and the tire outer surface, under the tread, is constant and provides a uniform wall thickness that is selected to support a certain load when the cavity is at atmospheric pressure, and to provide a load transfer from the tire tread into the rim at ends of the arch shaped cavity having an arch of from one hundred seventy (170) to one hundred forty (140) degrees.

Still another object of the present invention is to provide an elastomeric tire where the arch shaped cavity is formed both within the tire and as the tire casing exterior to have a uniform arc and with the thickness of the side walls and top area, under the tread, selected for a load as the tire will support when the cavity is at atmospheric pressure, and the arc of which arch shaped cavity is a uniform arch of from one hundred forty (140) to one hundred seventy (170) degrees from a line across the tire below support points located on opposite sides of a rim whereto the tire is maintained.

Still another object of the present invention is to provide an elastomeric tire that is preferably formed by molding methods in a range of sizes from, bicycle tires to high duty tires, with each tire to have an inherent strength as governed by a uniform thickness between a center arch shaped cavity surface and the tire outer surface, under the tread, and can support, with the tire arch supported at one hundred seventy (170) degrees and less between rim support point, a design load with the cavity at atmospheric pressure, and can, through a standard tire stem fitting, receive air passed under pressure into the arch shaped cavity, for increasing the effective tire load supporting character.

Still another object of the present invention is to provide a tire whose inherent load supporting characteristics can be enhanced by an addition of plies, a belt or belts, mounted in the tire during its manufacture and can further include the mounting of beads around the opposite tire sides, at the tire inner circumference.

Still another object of the present invention is to provide a tire, with or without plies, belts or beads where the tire includes the arch shaped interior cavity that functions as a load bearing member for a selected tire thickness between the cavity surface and the tire outer surface, below the tread, providing a tire having an effective load bearing capability when at atmospheric pressure, and can be aired to function as a pneumatic tire, increase the tire load bearing capacity.

The present invention is in a unique elastomer tire that is formed by molding methods from natural or synthetic rubber, urethane, or the like, preferably by a spin casting process, or processes, like those set out in U.S. Pat. Nos. 4,855,096; 4,943,323; 5,906,836, and 6,165,397, that the present inventor is a joint inventor of, and improvements thereto. Manufacture of the tire of the invention, as by such molding process or processes, may include a continuous bladder that is positionable in the tire mold wherearound the elastomeric material is injected, forming the arch shaped cavity centered under the tread. With, after curing, the tire is first removed from the mold, followed by a removal of the bladder from the tire. If the tire is formed so as to be closed across a web area, as for fitting in a rim, such as a bicycle rim, a center slit is made therearound to allow the bladder to be removed. If the tire is formed to be open across its web area, where the tire side walls each terminate in an end or a bead end section that are each to be supported between rim inner and outer upright walls, the bladder can be pulled directly out from inside the tire. Alternatively, the mold can be formed with an interior mandrel to cast the tire therearound. Both the bladder or the mandrel are for positioning in the center of the mold cavity to provide an arch shaped center, with the elastomeric material to flow freely therearound. Accordingly, with the bladder removed, or after the tire is pulled off from the mandrel, the molded tire will have an interior arch shape cavity centered under the tire tread.

A proper tire arch shaped cavity will have a uniform radius taken from a point of origin of the arch, with a maximum arc of the arch being one hundred seventy (170) degrees whereby the points of engagement of the arch ends to the rim hook ends is above a line through which arc point of origin. This provides, with the tire at ambient pressure, a very stable side wall junction with the tire, supporting the under load with little tire flexure at its rim junctions.

The tire inner and outer surfaces around the arch, below the tread, are spaced a like distance apart, providing a uniform thickness of tire material. For the tire to support a design load, at an ambient air pressure, the cavity surface is formed to have a uniform arc of from one hundred seventy (170) to at least one hundred forty (140) degrees as taken from aligned points across the tires sides whereat the tire is supported to a rim, and with the outer surface of the tire, below the tread, exactly following the arc of the inner cavity. The distance between the cavity inner and tire outer surfaces, or wall thickness, is the same as measured between, approximately, the tire junctions with the tops of the rim side walls, around the tire. This thickness, along with a selection of an appropriate elastomeric chemical combination, provides for supporting a particular load as the tire will carry, and which wall thickness is increased as the load increases. So arranged, the cavity arch and the selected tire casing thickness to a like outer arch, under the tread, provides a unique load bearing structural support with the cavity at atmospheric pressure to support a design load. Additionally, the tire interior arch shaped cavity can be aired to an appropriate pressure to further increase its load carrying capability, and with, to further increase the inherent load bearing capability of the un-inflated tire, such as a heavy duty cycle tire, the tire side walls across and under the tread can be reinforced by an inclusion of plies and/or with one or more belts included under the tread. For mounting the tire onto a rim, the tire can include beads, and with the plies, belt or belts, and with beads cast within the tire, to become an integral part of the tire.

Still other benefits and advantages of the invention will become apparent to those skilled in the art to which it pertains upon a reading and understanding of the following detailed specification.

### DESCRIPTION OF THE DRAWINGS

The invention may take physical form in certain parts and arrangement of parts, and a preferred embodiments of which will be described in detail in this specification and illustrated in the accompanying drawings which form a part hereof:

FIG. 1A is a cross section perspective view of a automotive tire of the invention that has an internal arch shaped center cavity is shown formed with an arc of one hundred seventy (170) degrees and the tire is arranged for mounting onto a rim, with the tire shown as being open across a bottom area to resemble a pneumatic tubeless tire, and showing a first tread embodiment;

FIG. 1B is a view like that of FIG. 1A only showing another tread embodiment;

FIG. 2A shows an automotive tire like that of FIG. 1B that is under load, illustrated by arrows M;

FIG. 2B shows a tire like that shown FIG. 2A only illustrating the load with arrows N:

FIG. 2C shows a tire like those shown in FIGS. 2A and 2B, but illustrates an applied load with arrows O;

FIG. 2D shows a tire like those shown in FIGS. 2A, 2B and 2C, but illustrates the load with arrows P;

FIG. 2E shows a graph of tire wall thickness T1 through T4 against applied load, to summarize the relationships of FIGS. 2A though 2D;

FIG. 3A is a sectional view of a bicycle tire embodiment of the invention shown mounted onto a bicycle rim and showing a section of a mandrel aligned for fitting in an arch shaped inner cavity of the tire;

FIG. 3B is an enlarged end sectional view taken along the line 3B-3B of FIG. 3A showing the bicycle tire removed from the bicycle rim as having been split across the tire rim contacting base from the rim engaging web surface into the arch shaped cavity;

FIG. 4 is a view like that of FIG. 3 showing the tire mounted onto another bicycle rim and with an air retention band shown as an inverted T fitted into the split;

FIG. 4A is an expanded sectional view of the air retention band of FIG. 4 FIG. 4B is a view like that of FIG. 4A showing a valve stem as having been installed through the rim web, tire rim contacting base, and into the arch shaped cavity;

FIGS. 5A, B, C, D and E show the footprint of a tire of the invention under load pressures applied thereto of 50; 75; 100; 125 and 150 pounds, with the arch shaped center cavity at atmospheric pressure, showing the tire tread spread at the different applied loads;

FIGS. 6A, B, C, D and E show the footprint of a pneumatic tire pressurized to thirty five (35) psi, that has load pressures applied thereto of 50; 75; 100; 125 and 150 pounds;

FIGS. 7A, B, C, D and E show the footprint of a pneumatic tire pressurized to forty (40) psi, that has load pressures applied thereto of 50; 75; 100; 125 and 150 pounds;

FIG. 8 shows a side elevation view of a section of a tire that has a centered internal arch shaped cavity and is formed with an arc of one hundred forty (140) degrees, is mounted onto a rim, with the tire shown as being formed to resemble a pneumatic tubeless tire, and is open across a bottom area to fit in a rim that includes supports to maintain the tire side wall ends inner and outer surfaces at the ends of the one hundred forty (140) degree arc.

FIG. 9 shows a tire like that of FIGS. 1A and 1B that is mounted onto a rim, with the tire shown as including beads maintained within the tire ends wherefrom a continuous section extends between the cavity wall and the tire outer surface, functioning as tire plies and a belt; and

FIG. 10 shows a side elevation view of the rim whereon the tire of FIG. 9 is mounted.

### DETAILED DESCRIPTION

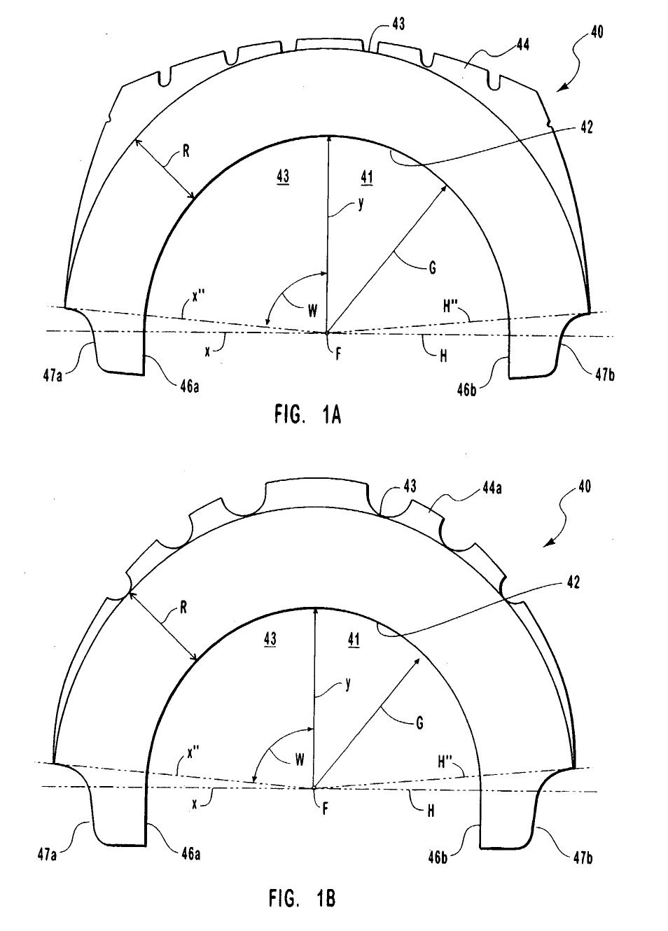

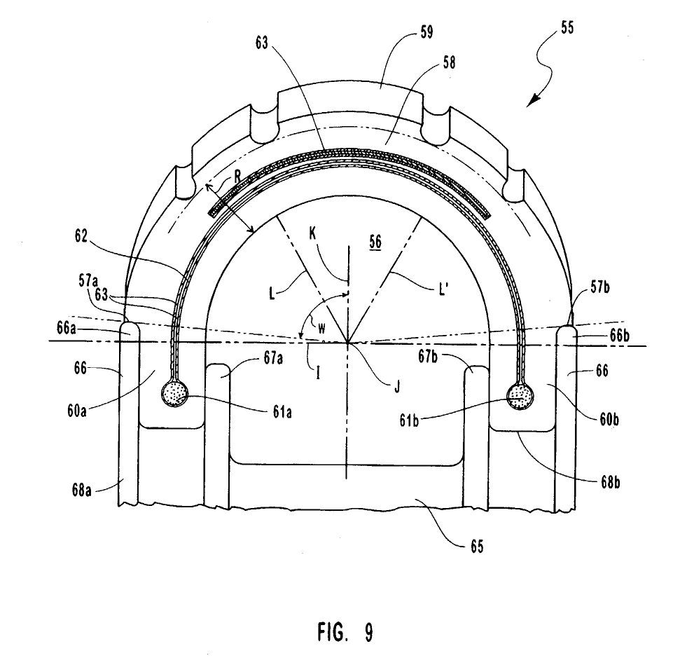

An automobile tire 40 of the invention is shown in FIGS. 1A, 1B and 8. An automobile tire 55 is shown in FIG. 9 that is the tire of FIGS. 1A, 1B and 8, that further include internal beads and a combination of plies and belts, mounted within the tire and secured, at its ends, between the beads. Which embodiments of automobile tires and their unique construction and are discussed in detail herein below.

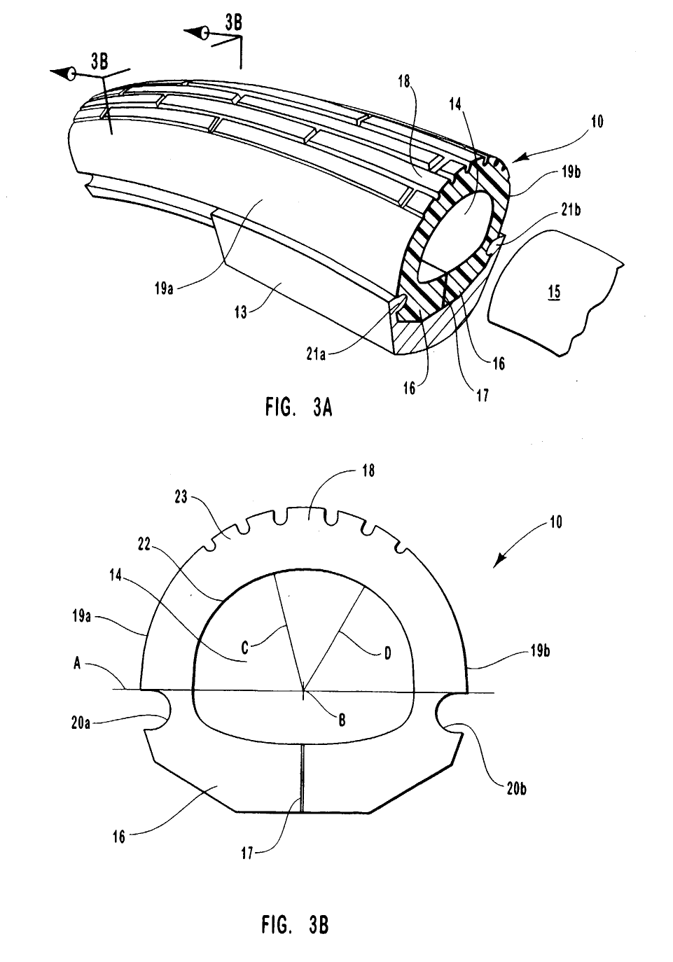

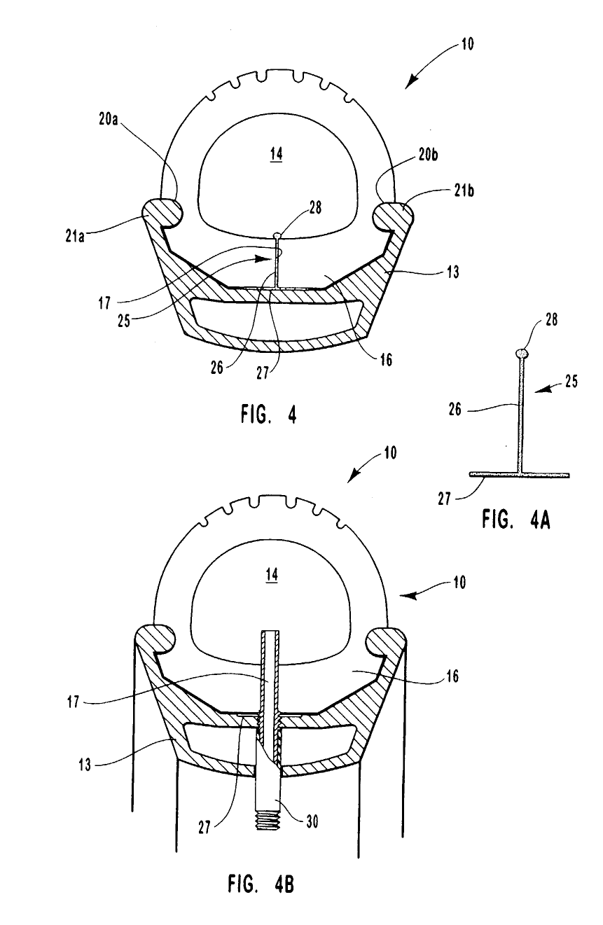

FIGS. 3A, 3B 4 and 4B show a bicycle tire 10 embodiment of the invention, that is shown in FIGS. 3A, 4 and 4B mounted onto a rim 13, and is shown alone in FIG. 3B. The tire 10, as do the other embodiments of tires 40 and 55 of the invention, described below, includes a casing or body that is preferably formed from an elastomeric material, such as a urethane material, preferably utilizing spin casting methods like those described in apparatus and method patents, U.S. Pat. Nos. 4,855,096; 4,943,323; 5,906,836 and 6,165,397, that the present inventor is a co-inventor of. Though, it should be understood, the invention could be manufactured from other elastomeric materials, such as natural or synthetic rubber, and by other methods and apparatus from that shown in the above set out U.S. Patents, to include: molding where a urethane or rubber material, in a liquid form, is poured into a mold; or by a pressure molding of a rubber material where the material is squeezed, as in a mold, into a tire shape; or a like process or procedure can be employed to form the tire or tires of the invention, within the scope of this disclosure. It should therefore be understood that the invention resides in the unique arch shaped interior cavity and its mounting in a rim, with a selection of tire wall thickness, alone provides for load bearing structural strength, and not in a particular manufacturing process or material used in that manufacture. The arch shaped cavity in conjunction with the tire side walls mountings in a rim, provides for the tire being under a compressive load at all times, with those load forces directed around the arch and into the tire mounting points to the rim. Tire load bearing ability is inherent in the structure of the arch shaped cavity and is present even when side loads are exerted against the side of the tire. So arranged, the tire of the invention will exhibit a load bearing ability even at atmospheric pressure in the arch shaped cavity, supporting a design load for a particular or selected thickness or distance between the tire interior cavity wall and the tire outer surface, under the tire tread. Which tire load bearing strength can be increased by adding air to the cavity, as through a valve stem, or the like.

Heretofore, tires formed with cavities have not utilized the arch shape as a load supporting member, with that load bearing ability directly related to tire thickness, as does the invention. Unique to the invention, an automobile tire arch shaped interior cavity is a uniform curve, that is preferably a curve from zero degrees at a horizontal line X from one tire side, through an arc or one hundred seventy (170) to not less than one hundred forty (140) degrees to line H, as shown in FIGS. 1A and 1B. The line X is shown in FIGS. 1A and 1B as a broken line from a left tire side to the tire center F, that intersects a vertical line Y, that vertically bisects the tire 10, with the horizontal and vertical lines X and Y meeting at point F, that is the point of origin of the radius for the arch shaped cavity and the arch of outer tire surface, below the tread 44, as shown in FIG. 1A and tread 44, as shown in FIG. 1B. As shown in FIGS. 1A and 1B, the arch shaped cavity wall 42 is formed with one hundred seventy (170) degrees of arc, with half that arc, or eighty five (85) degrees illustrated by angle W between a broken line X″ and the vertical line Y, with the angle of arc on the other, or right side, of vertical line to broken line H″, being the mirror thereof, or eighty five (85) degrees. An arc or one hundred seventy (170) degrees should therefore be understood to be the maximum arc of a automobile tire 40 embodiment of the invention, with the cavity arch and the casing outer arch, below the tread, being the like arc of a maximum of one hundred seventy (170) degrees, with connection curved inner sections or mounting grooves 47a and 47b top portions thereby being above the horizontal lines X and H, that receive and provide a columnar support to the tire side walls. So arranged, the arch shaped cavity provides the tire 40 with the load bearing capability to support, in compression, a design load with the arch shaped cavity at ambient pressure within the cavity only. Where, for the arc of one hundred seventy (170) degrees, loads passed from the thread into the tire walls travel as compressive loads only into the rim contact points with mounting grooves 47a and 47b. In practice it has been found that for a greater arc than one hundred seventy (170) degrees, the junction of which mounting grooves 47a and 47b with the rim can experience part of a load carried by the tire as shearing forces, particularly when the tire is subjected to side loads. Such shear forces can create flexure of the tire side wall such a heat build-up and potential damage to the tire over time, and which shearing loads are not present where the arc is one hundred seventy (170), and less.

As shown in FIG. 8, and as further set out below, a tire 40 of the invention to continue to exhibit essentially only compressive loading, while still exhibiting a pneumatic tire like performance, can be formed to have an arc of not less than one hundred forty (140) degrees and still provide the required load bearing strength of the tire of the invention. Accordingly, the automobile tire 40, and the other tire embodiments or the invention, provide desired a design load bearing strength, when the arc of the inner and outer arches is between one hundred forty (140) to one hundred seventy (170) degrees, under the tread 44 or 44a, avoiding unwanted flexure of the tire side walls at their junctions with the rim. Which inner and outer arches are equidistant from one another, as illustrated as arrow R, as shown in FIGS. 1A and 1B, and are centered on a vertical line Y that divides the tire at its intersection with a horizontal lines X and H.

The rim points of contact with the tires of the invention are as discussed with respect to the embodiments of tires 10, 40 and 55, shown in FIGS. 1A, 1B, 3A, 3B, 4, 4B, 8 and 9, that illustrate both bicycle and automobile tires, though, it should be understood, as the bicycle tire that is not anticipated to need to carry a heavy load, as compared to an automobile tire, as shown in FIG. 3B, may incorporate a cavity arch having an arc of one hundred eighty (180) degrees. However, such bicycle tire, like the automobile tires of FIGS. 1A and 1B, and other tires as incorporate the arch shaped cavity, with a design wall thickness for a design load, will preferably have a maximum arc of one hundred seventy (170) degrees, within the scope of this disclosure.

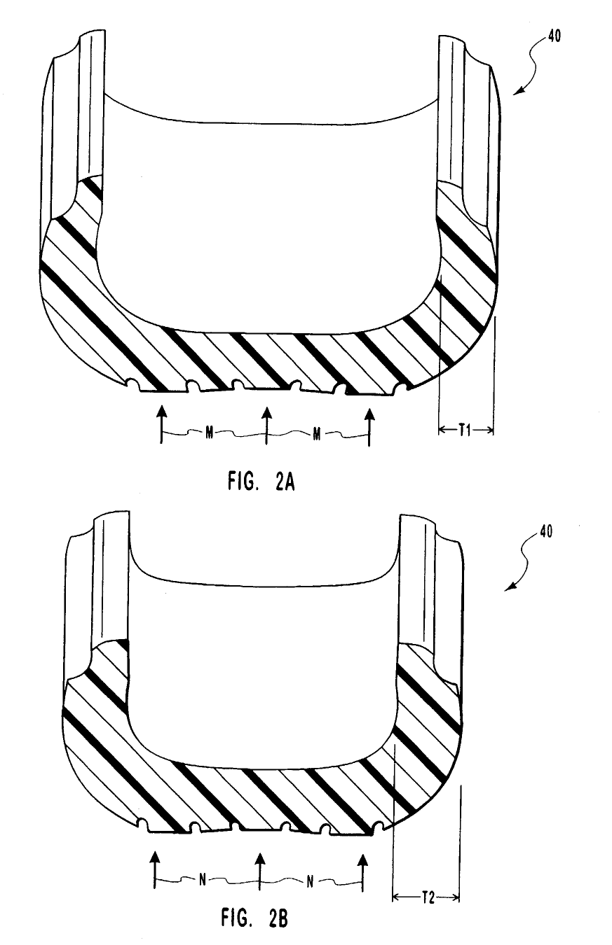

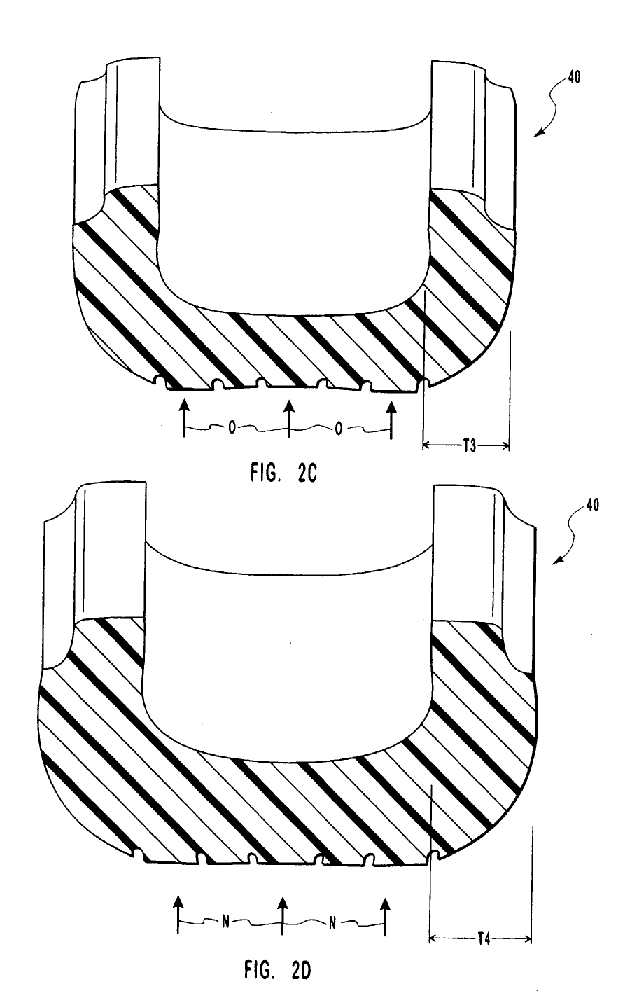

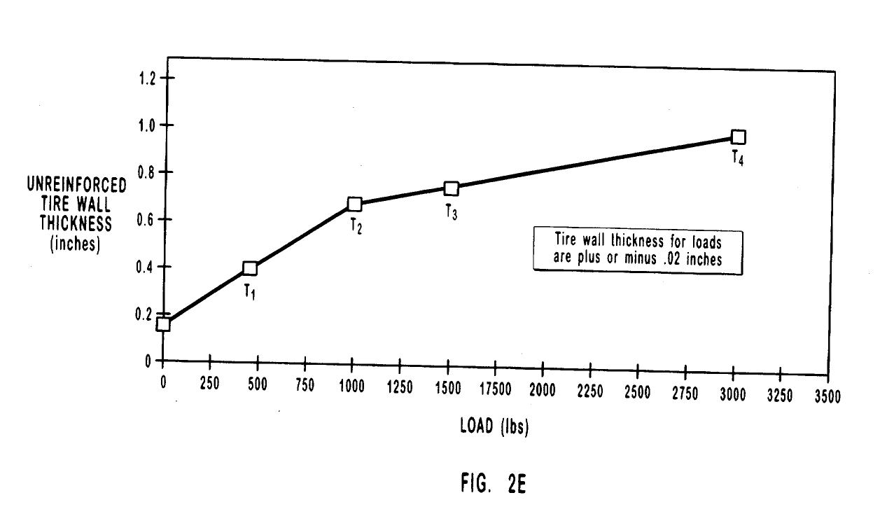

The arc for the centered arch shaped cavity, as shown in FIGS. 1A and 1B, utilizes an appropriate length of a first radius G, as the wall 42 of the arch shaped cavity 43 and a second radius H, that is scribed from the same point of origin as the first radius G, to form the tire outer surface, below the tread 44, as shown in FIG. 1A and 44a in FIG. 1B. A uniform wall thickness between the tire 40 inner cavity and tire outer surface, under the tread, shown as arrow R, is thereby provided that, as shown in FIGS. 2A, 2B, 2C and 2D, is selected to provide a desired or design load bearing capacity when the inner cavity is at atmospheric pressure. The tires 10, as well as the tires 40 and 55, it should be understood are each preferably formed from an elastomeric material that is a combination of an isocyanate and a polyol as a chain extender that are sprayed together in the spin casing process to form the tire 10, 40 and 55.

FIG. 2A shows, with arrows M, a force directed into tire 40, that is the force shown also in the graph of FIG. 2E, and illustrates an anticipated tire load of four hundred (400) pounds. Which load, to be supported, requires a tire wall thickness, T1, of at least 0.40 inches, plus or minus 0.02 inches. FIG. 2B shows, with arrows N, a force directed into tire 40, that is the force shown also in the graph of FIG. 2E, and illustrates an anticipated tire load of one thousand (1000) pounds. Which load, to be supported, requires a tire wall, T2, of at least 0.70 inches, plus or minus 0.02 inches. FIG. 2C shows, with arrows O, a force directed into tire 40, that is the force shown also in the graph of FIG. 2E, and illustrates an anticipated tire load of fifteen hundred (1500) pounds. Which load, to be supported, requires a tire wall thickness, T3, of at least 0.75 inches, plus or minus 0.02 inches. FIG. 2D shows, with arrows P, a force directed into tire 40, that is the force shown also in the graph 2E, and illustrates an anticipated tire load of three thousand (3000) pounds. Which load, to be supported, requires a tire wall thickness, T4, of at least 1.00 inch.

The graph of FIG. 2E summarizes the load to tire wall thickness relationships, as set out in FIGS. 2A through 2D, where each tire wall thickness is set out, plus or minus point zero two (0.02) inches above a four hundred (400) pound load, and shows a minimum thickness of approximately point one six (0.16) inches as an intercept with the wall thickness axis, and with a straight line extending therefrom to a thickness T1 of point four (0.4) inches, for a load of four (4) hundred pounds, as shown in FIG. 2A. The graph shows a straight line relationship with a uniform slope between the loads of from a minimum tire thickness to four hundred pounds, is shown in FIG. 2E. From which tire thickness T1 to T4 the slope is also approximately a straight line relationship, but is at a lesser slope. FIG. 2E thereby demonstrates that, from a minimum thickness, the tire side wall, for a tire at ambient pressure only, increases proportionally to increases in load. Which thickness increase, is at a greater slope between the intercept with the tire thickness axis and T1, and is lesser between T1 and T4, indicating that the increases as are necessary to support a design load of from approximately four hundred (400) pounds to three thousand (3000) pounds are less dramatic than the thickness changes as are needed to support a load of from zero to four hundred (400) pounds. The FIGS. 2a through 2D and the graph of FIG. 2E thereby demonstrate the direct relationship between tire wall thickness and a load the tire can carry or support when the arch shaped cavity is at approximately atmospheric pressure.

The tire wall thickness, as discussed above, is defined as a uniform wall thickness from the tire points of engagement or support points around the tire, under the tire tread, and two variations of tire treads, as are appropriate for use with the automobile tire of the invention, are show in FIGS. 1A and 1B, as treads 44 and 44a. As set out above, the uniform tire wall thickness varies with load for an arc of not less than one hundred forty (140) degrees to not more than one hundred seventy (170) degrees, to provide the required support strength to support loads like those set out in FIGS. 2A through 2D above.

FIG. 3A shows a section of the bicycle tire 10 mounted in a section of a bicycle rim 13 that includes the arch shaped cavity 14 centered under the tire tread 18. The tire 10, like the tires 40 and 55, is formed from an elastomeric material, preferably a urethane material, but may be natural or synthetic rubber, or the like, and each tire is preferably manufactured by spin casting apparatus and practicing of casting methods like those set out in the above cited U.S. Patents. Like which tires 40 and 50, however, the tire 10 may be formed by molding methods including an injection of a liquid elastomer into a mold, or by pressure molding methods, within the scope of this disclosure. In preferred spin casting method for forming the tire 10, a bladder 15, shown as a section in FIG. 3A, that may be solid or an air inflatable bladder, is fitted into a cavity of a tire mold, not shown, and receives an elastomer injected therearound, in the spin casting process. Which elastomer may, as with tires 40 and 50, be a natural or synthetic rubber, or the like, within the scope of this disclosure.

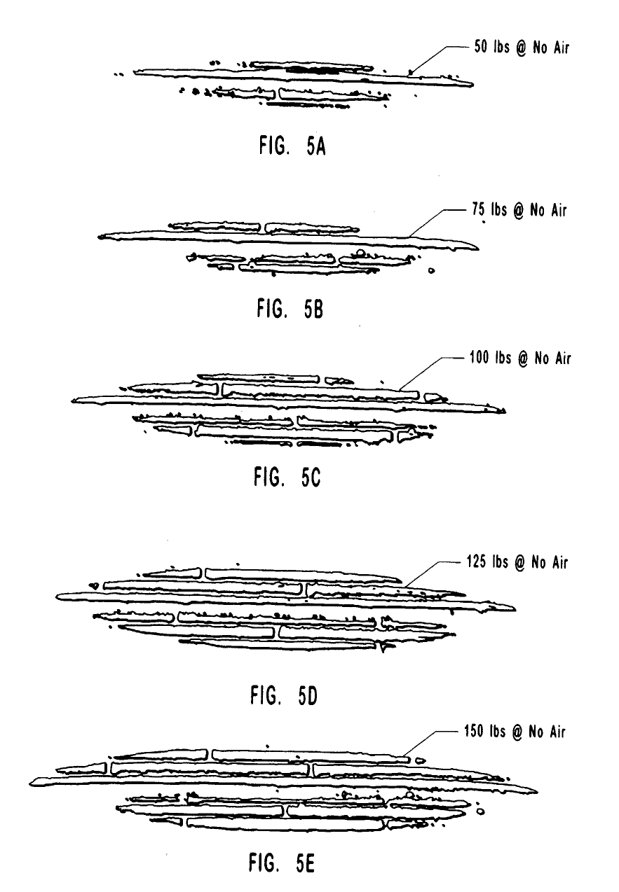

After curing of the tire 10, the mold is opened and the tire containing the bladder is removed. Thereafter, a tire rim engaging section 16, that is formed across the tire 10 web, can then be slit at 17, as with a tool, not shown. Which slit 17 is shown also in FIGS. 3B, 4 and 4B. Or such mold can include a divider to form the longitudinal slot 17 around the mold tire rim engaging web portion 16. The tire 10 can be spread apart at the slot 17, and the bladder 15 pulled therefrom. So formed, as will be discussed later herein with respect to a comparison of tire foot prints for the tire 10, as shown in FIGS. 5, 6, and 7, A through E, the arch shaped cavity provides a uniform transfer of forces from the tire tread 18 area, through the sides walls 19a and 19b that, as set out above, has a wall thickness that is selected for the anticipated tire load. Additional to compressive forces transfer as is provides by the arch shaped cavity 14 of tire 10, and the arch shaped cavities of tires 40 and 55, the tires arch shaped cavity provides resilient cushioning to absorb bumps and produce a ride that is comparable to that of a like design of a properly aired pneumatic tire.

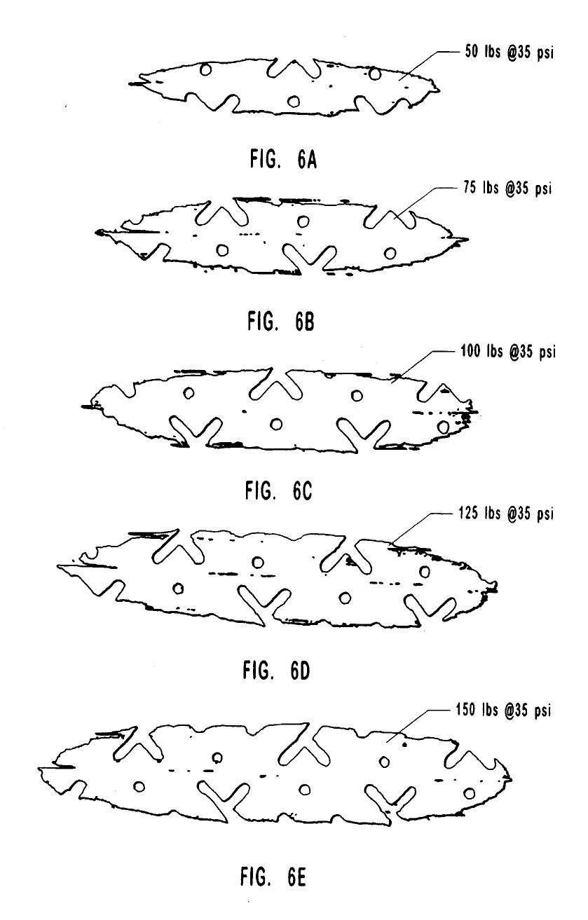

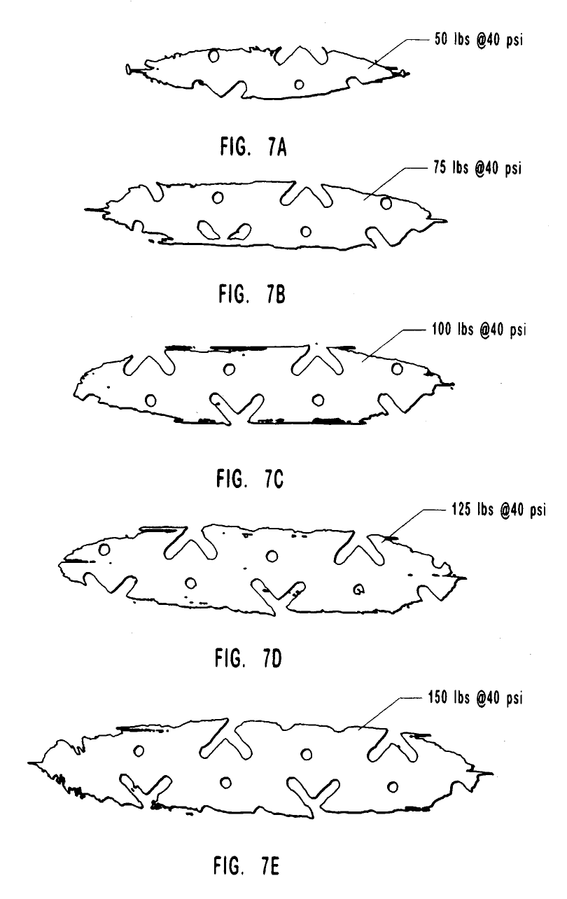

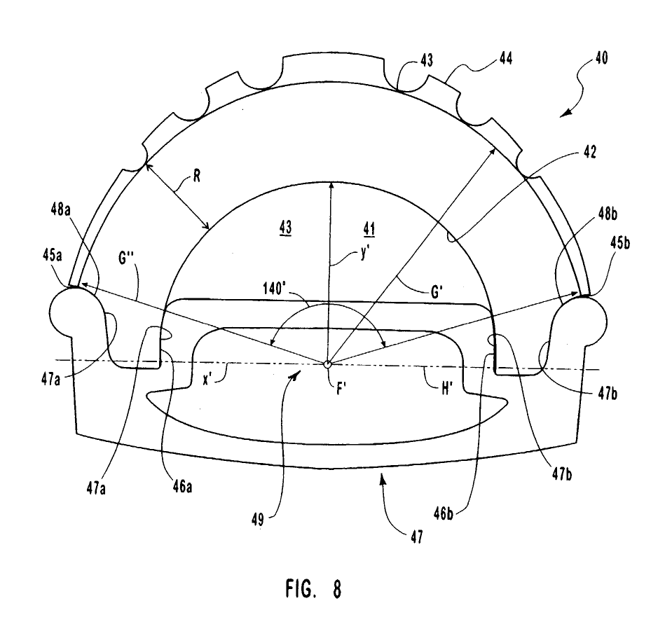

An illustration of the load bearing characteristics of the tire 10 are shown in the foot prints of FIGS. 5A-5E; 6A-6E and 7A-7E. FIGS. 5A-5E show the tire as containing only air at ambient air pressure being subjected to loads of 50; 75; 100; 125 and 150 pounds, respectively. With FIGS. 6A-6E and 7A-7E, showing a like pneumatic tire 10 that has been aired to thirty five (35) and forty (40) psi, respectively, supporting the same loads as tire 10. A comparison of the footprints clearly shows that the tire 10, without air, has load supporting abilities that are equivalent to those of a pneumatic tire pressurized from thirty five (35) to forty (40) psi. Further, tire 10 cavity 14 can be pressurized to a greater effective pressure for added load carrying capacity by pumping air into the cavity 14. In practice, while the automobile tire footprints of the tires 40 and 55 will, of course, be wider than those of the tire 10, they will exhibit like comparisons to pneumatic tires aired to thirty five (35) to forty (40) psi, respectively, and carry equivalent loads, as shown in FIGS. 2A through 2D. With for all the tire 10, 40 and 55 embodiments, and tires like those shown herein, air under pressure can be added to the tire interior arch shaped cavity to increase the tire's inherent load supporting strength. In practice, for every pound of air pressure added to the tire arch shaped cavity, the tire effective pressure is increased by that added pound of pressure.

FIG. 3A shows the tire 10 as including like shaped mounting grooves or slots 20a and 20b formed around the tire side walls, above the junction of the tire side walls ends 19a and 19b. The grooves or slots 20a and 20b are each to receive a rim hook end 21a or 21b that are formed as ends of the sides of a crochet hook type rim 13. Which tire 10 includes a tire rim engaging web portion 16 that is arranged to fit in which rim 13. For mounting the tire 10 in rim 13, With the rim hook ends 21a and 21b fitted into grooves or slots 20a and 20b, maintaining the tire 10 on the rim 13.

The tire 10 is preferably formed like the tires 40 and 55. As an illustration of how the tire 10 arc of the arch shaped cavity is arranged, FIG. 3B shows, a straight line that is drawn across the tire, just above the tops of which mounting slots 20a and 20b, identified as lateral axis A. The junction of which lateral axis A, to the center of the tire, between the side walls, is illustrated as point B. Point B illustrates the location or point of origin from where a radius C is swung through one hundred eighty (180) degrees, as the cavity arch wall 22. Which arc, as swung by radius C, can be one hundred eighty (180) for the bicycle tire 10 that carries a much lighter load than an automobile tire will carry, but is still preferably one hundred and seventy (170) degrees as it is for both tire 40 and 55, as set out above. The outer tire 10 shape, below the tread 18, is illustrated as being formed utilizing a second radius D, that, as shown, has a greater length than radius C, and is also swung from the point B, through one hundred eighty (180) degrees to form the tire outer arch, forming tire side wall 19a or 19b and a tire top portion, under the tire tread 18. The distance between the lengths of the radiuses C and D is the tire side walls and top portion thickness, below or under the tread, from the tops of the mounting slots 20a and 20b. It is this thickness that is selected to support the anticipated load the tire will carry with only ambient air pressure in the arch shaped cavity 14. For example, for a standard twenty six (26) inch bicycle tire that is designed to carry a load of approximately one hundred fifty (150) pounds, the tire wall and top thickness, under the tread to the arch shaped cavity, is approximately point one six zero (0.160) of an inch. This is a minimum thickness to provide a tire that, without air under pressure in the arch shaped cavity, will have a load carrying strength like that of a pneumatic tire pressurized to approximately thirty five (35) to forty (40) psi. As set out above, the requirement for a uniform wall and top portion tire thickness does not include the tread height that, it should be understood, does not effect the tire load supporting characteristics.

Summarizing the above, the bicycle tire 10 includes the arch shaped cavity centered under the tread and with the tire side walls and area below the tread having the same thickness. This structure provides a bicycle tire having the inherent load supporting character for a uniform wall thickness of a minimum of approximately zero point one six (0.16) inches, to provide a load bearing tire that is at least equivalent to a pneumatic tire designed to support a like load to that of bicycle tire 10 and is pressurized to a pressure between thirty five (35) and forty (40) psi. So arranged, the bicycle tire 10 can be additionally pressurized by the passage of air under pressure into the arch shaped cavity 14, providing added load carrying capability.

FIG. 4 shows the bicycle tire 10 mounted onto rim 13, with the rim shown as a crochet hook type rim that includes tire mounting side hooks 21a and 21b. The side hooks 12a and 12b are seated in the tire grooves or slots 20a and 20b, respectively. Prior to mounting the bicycle tire 10 onto rim 13, for closing the arch shaped cavity 14 to allow it to hold air under pressure, a continuous sealing band 25, shown as an inverted T is provided. The continuous sealing band 25 inverted T is shown as having been removed in FIG. 4A. The continuous sealing band 25 is formed as a continuous ring from a flexible material, such as rubber, to fit in the tire slot 17. The continuous band 25, formed as an inverted T, has a straight section 26 that connects, at one end, and at a right angle, to the center of a crossing section 27, and includes a ball 28 shaped bead formed on the opposite straight section 26 end. Prior to installation of the tire 10 onto the rim 13 the continuous band sealing 25 ball shaped bead 28 and straight section 26 are fitted through the tire slot 17 to where the surface of the center crossing section 27 contacts the tire web portion 16, at the slot edges. This arrangement provides, when the tire 10 is installed in the rim 13, as shown in FIG. 4, an air tight seal. To pass air under pressure into the tire arch shaped cavity 14, a standard valve stem 30, shown in FIG. 4B, is installed through the rim 13, through an opening through the continuous sealing band 25 center crossing section 27, and into the arch shaped cavity 14. So arranged, air is passed under pressure through the threaded end 31 of the stem 30 and travels into the cavity. The pressure of such injected air adds to the tire inherent load bearing strength, whereby, for example, with the cavity pressurized to fifteen (15) psi, the tire 10 will exhibit an inherent load bearing strength that is a pressure equivalent of a pneumatic tire aired to approximately fifty five (55) psi.

FIGS. 5A through E show the footprint of the bicycle tire 10 under the indicated loads of fifty (50); seventy five (75); one hundred (100); one hundred twenty five (125); and one hundred fifty (150) pounds of load, respectively, with the arch shaped cavity 14 at atmospheric pressure. FIGS. 6 and 7, A through E, show the foot print of a pneumatic tire that is of a like size and for supporting a like load to that of tire 10. Which pneumatic tire is pressurized to, respectively, to thirty five (35) and forty (40) psi. A comparison of the foot prints of the tire 10 with those of the pneumatic tire pressurized to thirty five (35) and forty (40) psi, respectively, shows that the tires have essentially the same foot print. This indicates that the bicycle tire 10, without air under pressure therein, will exhibit essentially the same support, stability and ride characteristics of a pressurized pneumatic tire.

FIG. 8 shows an automobile tire 40 embodiment of an air no air tire of the invention that is essentially like the tire of FIGS. 1B and 2A through 2D, except that this tire 40 is shown as having an arch shaped cavity where the arc of which cavity is one hundred forty (140) degrees. This arch, for example, is formed by lowering the point of origin, shown as F′, to below a horizontal line X′ that extends across lower end corners 45a and 45b of the tire outer surface, below the tread 44a, and include curved inner sections or mounting groves 47a and 47b that each fit against inner surfaces of hook ends 48a and 48b of rim 47, mounting the tire to the rim. A vertical center line is shown extending through a right angle junction with horizontal line X′ a selected distance to the point of origin F′, therebelow. Thereby, for a selected distance of point F′ below the crossing point of the center vertical line and horizontal line X′, a radius G′ swung from point F′ to have an arc of approximately one hundred forty (140) degrees. A radius H′ is also swung from point F′ to form an outer surface 43 of the tire 40, below the tread 44a. The tire 40 is preferably manufactured from an elastomeric material, preferably a urethane, by spin casting methods, but may be formed from a natural or synthetic rubber, or the like, by liquid or pressure molding methods, within the scope of this disclosure. In which preferred spin casting method of manufacture, a mold is formed to cast tire 40 that is open between its lower or web ends 46a and 46b will fit in a rim 47. Shown in FIG. 8, the tire 40 side wall ends 46a and 46b, are located below the curved inner sections 47a and 47b and are to fit between outer support hook end sides 47a and 47b and vertical sides 48a and 48b of a rim web upstanding center platform 49.

The tire 40, like the tire 10, as described above, is formed with the arch shaped cavity 41, that, as shown in FIG. 8, includes a radius H′ that is swung from point F′ through, one hundred forty (140) degrees of arc, illustrating a lower range of acceptable arcs of an arch shaped cavity of the tire of the invention. The longer radius G″, is also swung through one hundred forty (140) degrees from the point F. So formed, the inner arch shape cavity 41 arc and the arc of the tire outer arch 43, below the tire tread 44a, are alike, and the distance therebetween, or thickness R, is the same. So arranged, for both arch shaped cavities of tire 40 of FIGS. 1A, 1B and 8, like the tire 10, the distance R between the inner cavity 42 and outer side walls and top area 43, under the tread, is the same, and is carefully selected, as shown in FIGS. 2A through 2E, for the anticipated load as the tire will carry. FIG. 1A, 1B and 8 thereby illustrate that the arc of the arch shaped cavity 41 of the tires 40 can be from one hundred forty (140) up to and including one hundred seventy (170) degrees to maintain, in compression and without air above ambient being present in the cavity, a design load.

Like the bicycle tire 10, the arch shaped cavity 41 of tire 40 alone provides a load bearing structure that is essentially the equivalent of the support provided by a like pneumatic tire that is pressurized appropriately. In practice, the tire 40 has an effective load bearing character that is the equivalent of a pressurization of thirty five (35) to forty (40) psi of a tube type or tube-less pneumatic tire. Which effective pressurization can be increased by pressurizing the arch shaped cavity, as discussed above with respect to tire 10. The thickness of the tire 40 tread does not, in practice, effect the load bearing capabilities of the tires 10 or 40 and therefore may be any appropriate thickness to provide the desired road gripping, traction, wear and stability characteristics.

As set out above, the arch shaped cavity 41 is illustrated in FIGS. 1A, 1B, and 8, as having arcs formed by swinging radius G and G′ from points F and F′, respectively, through a maximum of one hundred seventy (170) degrees of arch to a minimum of one hundred forty (140) degrees of arc, respectively. It should therefore be understood that an arc of between one hundred forty (140) to one hundred seventy (170) degrees the side walls will provide satisfactory compressive load support. Accordingly, FIG. 8 shows the point F′ wherefrom the one hundred forty (140) degrees of arch are scribed, by the first radius G′, forming the arch shaped cavity 41, and by radius H′, forming the tire outer surface 43, below the tread 44, with a uniform distance R therebetween. So arranged, the arch shaped cavity ends are approximately on line with the tops of the tire side wall connection curved inner sections or mounting grooves 47a and 47b, that receive the rear surfaces of rim hook ends 45a and 45b, respectively, fitted therein. It should therefore be understood that the arch shaped cavity of the invention can be one formed through from approximately one hundred seventy (170) degrees to one hundred forty (140) degrees of arc and still provide a tire that, without air under pressure in the cavity for a specific wall thickness R, will safely support and transfer a design load into the rim, functioning like a fully aired pneumatic tire constructed to support a like load that is of a similar size and design load capability.

The tire 40 of FIG. 8, as set out above, is formed to resemble a conventional tube type or tubeless pneumatic tire for mounting on rim 47. In which mounting the tire side wall ends are fitted into the rim 47, with the rim hook ends 45a and 45b face outwardly such that their back surfaces fit, respectively, into the tire side wall connection curved inner sections or mount grooves 47a and 47b. So arranged, the tire 40 side wall interior ends 46a and 46b are supported against the rim center platform 49 outer walls 48a and 48b. As needed, to add additional mounting support, as shown in FIG. 9, beads 61a and 61b that are preferably hoops that are formed of a material, such as steel, carbon fibers, or the like, can be included in tire 55, fitted around and within the ends of the side walls to provide locking of the tire side wall ends in the rim 65. While a tire like tire 40 without beads has, in practice, functioned as a light automobile tire, it is preferred, to insure a secure tire mounting onto a rim, that beads are used. For some light vehicle application, such as for a motor scooter tire, however, beads may not be required. In practice, such a motor scooter tire without beads that incorporated the arch shaped cavity maintained at ambient pressure was found to safely support a load of seven hundred (700) pounds. Which tire was aired to a pressure of approximately six (6) pounds safely supported a load of one thousand (1000) pounds, illustrating the versatility of the tire 40 of the invention.

As set out above, the tire 55 of FIG. 9 is like the tire 40 of FIGS. 1A, 1B and 8, in that it has the same design, is formed from an elastomeric material, preferably a urethane elastomer, but may be formed from natural or synthetic rubber, or the like, by spin casting or molding methods, producing a tire 55 that is open between its side wall ends and includes an arch shaped cavity 56. The arc of which cavity 56 is also formed to have from one hundred forty (140) to one hundred seventy (170) degrees of arc, as illustrated by a radius L that is turned from a point J that is the intersection of a horizontal line I laid across the tire, just below the tire side walls support contacts with rim 65 side walls 66 top ends 66a and 66b, and vertical line K that vertically bisects the tire 55. The tire outer arch is illustrated as being turned also from point J by a longer radius L′. In practice, the inside and outside arcs must match, with the distance R between the inner cavity arch and the outer arch being uniform across the distance or thickness between the cavity walls to the tire side walls curved inner sections or mounting grooves 57a and 57b, and across the tire top portion 58, below the tread 59. Which distance R is selected for the tire anticipated load. The tire arch shaped cavity wall end portions 60a and 60b are narrowed at the curved inner sections or mounting grooves 57a and 57b into essentially parallel sides that terminate at ends 68a and 68b and are fitted between rim outer and inner walls 66 and 67a and 67b, respectively. The tire 55 side wall end portions 60a and 60b, like the side wall ends of tire 40, are for fitting in, and are supported on the rim sides 66 and 67a and 67b, respectively.

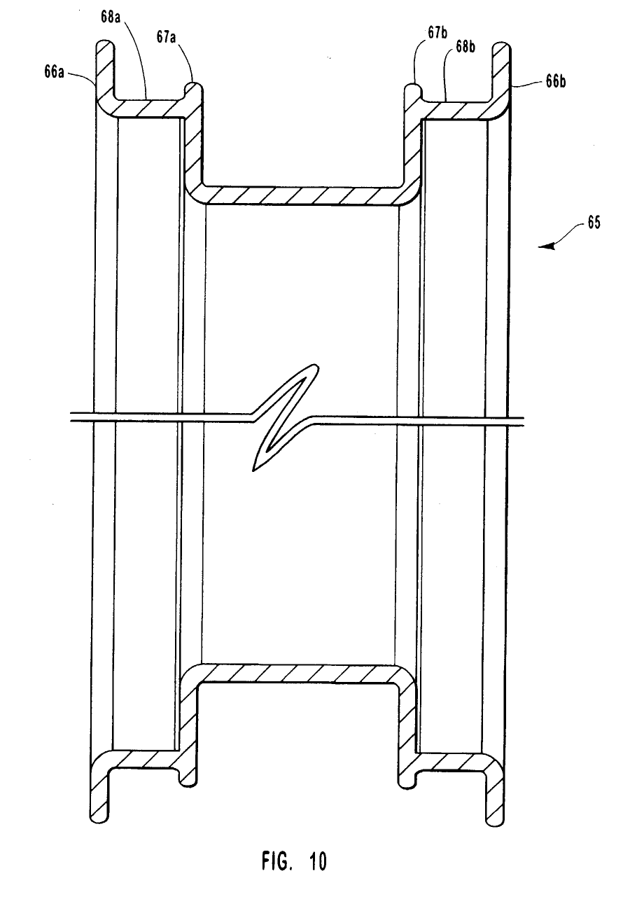

The tire 55, as shown in FIG. 9, is mounted to rim, like rim 65 shown in FIG. 10, as described above with respect to FIG. 9, and has, in practice, been produced as a high duty tire that is suitable for use on a light automobile. Like tires 10 and 40, tire 55 is preferably manufactured from urethane elastomer, natural or synthetic rubber, or the like, utilizing spin casting or liquid or pressure molding methods to have a wall thickness across the cavity arch, under the tire tread, that is selected to support a design load, as set out above with respect to the discussion of FIGS. 2A through 2E. So arranged, with the tire arch shaped cavity at atmospheric pressure, dependant upon the selected wall thickness the tire 55, like tires 10 and 40, tire 55 will support a design load, that can be further enhanced by the inclusion of beads 61a and 61b, and is reinforced with a ply or plies 62. Which ply or plies ends, as shown, can wrap around the beads 61a and 61b, and extend around the cavity arch, encapsulated between the arch shaped cavity wall and the tire outer wall. Further, a belt 63, as shown, or belts 63 can be fitted around the tire, between the plies and tread areas, with the combination of plies and belts functioning like separate belts and plies of a pneumatic tire. So arranged, the tire 55 with beads 61a and 61b, the continuous ply or plies 62, and belt or belts 63, is capable of supporting higher loads and/or which beads, plies and belt or belts are included for safety reasons. The ply or plies 62 and belt or belts 63 are preferably formed as flat meshes from fiber glass, carbon or graphite fibers, steel, or the like materials, and are installed in the tire 55 during the tire casting or molding process. At least one of which plies, as shown in FIG. 9, extends to the beads 61a and 61b, that are continuous hoops preferably formed from a high tensile strength material, and are installed at the end portions of the tire side walls. With the inclusion of beads 61a and 61b along with ply or plies 62 and belt 63 providing structural strength to the tire, the selected tire thickness R between the arch shaped inner cavity wall and the tire outer surface, under the tread, can be reduced while still retaining the design load carrying strength of a thicker walled tire.

The tires 10, 40 and 55, to carry an appropriate design load, are formed with the arch shaped cavity and to have a wall thickness as is appropriate to safely handle such design load. Further, each tire 10, 40 and 55, can include a valve stem, fitted thereto, as illustrated in FIG. 4B, or the like, for injecting air under pressure into the tire arch shaped cavity, for increasing the load carrying capability of the tire.

Preferred embodiments of the air no air elastomeric tire of the invention have been shown and described above. It will, however, be apparent to one knowledgeable or skilled in the art that the above described embodiments may incorporate changes and modifications without departing from the general scope of this invention. Which invention therefore is intended to include all such modifications and alterations in so far as they come within the scope of the appended claims and/or a reasonable equivalence thereof.

I claim

1. An elastomeric tire comprising, a tire casing formed by casting methods from an elastomeric material to have a continuous arch shaped interior cavity with the arc of said interior arch shaped cavity centered between end portions of said tire casing and including a tire casing outer portion that has a same arc as the arc of said interior arch shaped cavity, and said interior arch shaped cavity and said tire casing outer portion have a like uniform arc of from one hundred forty (140) to one hundred seventy (170) degrees, with said tire casing having a uniform thickness across said arches that is selected for a particular anticipated load as said tire will support with said inner arch shaped cavity at atmospheric pressure; a continuous tread portion secured around an annular surface to said tire casing outer portion; means for mounting said end portions of side walls of said tire casing to a rim; and a valve stem means installed through said rim and into said arch shaped cavity for passing air under pressure therein.

2. The elastomeric tire as recited in claim 1, wherein the tire casing side walls each include an identical mounting groove or slot that are each formed around a tire side wall end portion, with each said groove or slot for fitting to an end portion or slot of a rim side wall, for mounting said tire casing onto said rim.

3. The elastomeric tire as recited in claim 1, where the tire casing is open across the tire casing side walls, and the rim is provided with outer and inner upstanding side walls for receiving and supporting the lower end portions of said tire casing side walls; and the rim is fitted with a valve stem passed therethrough and into the arch shaped cavity for passing air under pressure therein.

4. The elastomeric tire as recited in claim 1, wherein the thickness of the material between the inner arch shaped cavity and casing outer portion arch, under the continuous tread portion annular surface, is selected to support, when said inner arch shaped cavity is at atmospheric pressure, an anticipate design load, with said thickness of material being less for a light load than a heavier load, and which said thickness of material increases in proportion with increases in anticipated load.

5. The elastomeric tire as recited in claim 4, further including a pair of like beads that are each fitted and cast within the lower portions of the casing side walls.

6. The elastomeric tire as recited in claim 5, further including at least a first ply formed from a mesh material and is installed in the tire forming process to encircle the tire top portion, below the tire tread and within the tire side walls, with ends of said ply extending to said tire side walls lower portions.

7. The elastomeric tire as recited in claim 6, wherein the mesh material is a mesh of fiber glass, a weave of graphite or carbon fibers, steel, or other appropriate material, formed into a flexible mesh material to extend around the tire casing.

8. The elastomeric tire as recited in claim 6, wherein the pair of like beads are each identical hoops formed from a material that is inelastic and has a high tensile strength, with each said hoop fitted in each of the lower portions of the tire side walls, and each said bead is in contact with an edge of the first ply secured thereto.

9. The elastomeric tire as recited in claim 8, further including a second ply formed of a material like that of the first ply and installed in the tire forming process to pass over the tire top portion, extending into the tire side walls lower portions and engage the beads.

10. The elastomeric tire as recited in claim 9, wherein the ends of each of said first and second plies are fitted around each bead.

11. The elastomeric tire as recited in claim 1, wherein the tire casing is formed from a elastomer by molding methods.

12. The elastomeric tire as recited in claim 11, wherein the tire casing is formed by spin casting methods.

13. The elastomeric tire as recited in claim 1, wherein the tire casing is formed form natural or synthetic rubber.

14. The elastomeric tire as recited in claim 14, wherein the tire casing is formed from an isocyanate and polyol as a chain extender that are combined together as sprays directed into a spin casting apparatus wherein the tire is formed.
